(19) United States
(12) Patent Application Publication
(10) Pub. No.: US 2023/0094600 A1
(43) Pub. Date: Mar. 30, 2023

(54) FOLDABLE MOBILE PHONE HAVING ELECTRONIC PAPER DISPLAY

(71) Applicant: HOULY CO., LTD., Taipei City (TW)

(72) Inventor: Kuo-Shen Liu, Taipei City (TW)

(21) Appl. No.: 17/483,829

(22) Filed: Sep. 24, 2021

(51) Int. Cl. H04M 1/02; G06F 3/0488

(52) U.S. Cl. CPC H04M 1/0268; H04M 1/0216; G06F 3/0488; H04M 2201/38

(57) ABSTRACT

The foldable mobile phone having an ePaper display added on a mobile phone through mechanical and electronic means so that the ePaper display shares the mobile phone's various mechanical and electronic units. The mechanical means allows the ePaper display to be folded towards or unfolded from the mobile phone. The electronic means allows various data such as text, pictures, videos to be shown from the mobile phone on the ePaper display. The ePaper display enhances the mobile phone's applicability and reduces harm to the eyes.

### BACKGROUND OF THE INVENTION

### (a) Technical Field of the Invention

The present invention is generally related to mobile phones, and more particular to a foldable mobile phone with dual displays where one display is made with electronic paper (hereinafter referred to as ePaper).

### (b) Description of the Prior Art

Human beings perceive the world and discern the shapes and colors of objects through sun or artificial lights reflected by the objects. This is changed after TV and mobile phones using the self-illuminating displays by LEDs or LCDs are invented. Looking at these direct light displays harms and fatigue eyes, especially for mobile phones due to their closer range to the eyes, and especially for the younger generation who own a mobile phone from their youth and spend longer period of time using the phone.

Main ePaper displays uses electrophoretic and electrowetting techniques to display by reflected light. Electrophoretic ePaper displays apply electric field to arrange charged pigment particles (microcapsules) and, by varying the electric field, viewers can perceive image changes as light reflected from the pigment white particles and colored oil filled in microcapsules. Electrowetting ePaper display apply electric field to water and water-repellent insulating coating. The water and colored oil will move by varying the electric field. Viewers can see different images as the light is reflected from the moving water and the colored oil.

The LED/LCD and ePaper displays have their respective pros and cons.

The greatest advantage of ePaper displays is that they cause the least amount of harm to viewers' eyes.

In addition, the images shown on ePaper displays can be clearly viewed even under direct sunlight. Their theoretical viewing angle is widened to 180 degrees with high contrast. Furthermore, when the images are not refreshed, they can be continuously displayed without consuming power. The major drawback of ePaper displays is that their refresh rate is too slow. Currently the refresh rate is about 1 fps (frames per second) for color images, and 8 fps for black-and-white images, which are way too low for the lowest 24 fps for video playing. In contrast, 4G mobile phones' LED/LCD displays can offer about 50 fps, and 5G mobile phones can be as high as about 90 fps. Existing mobile phones can also provide over 16 million colors whereas color ePaper can only offer 4096 colors. There is also a huge difference between their resolutions. Despite the continuous progress of ePaper techniques, it would be difficult for ePaper as the sole display for mobile phones, unless they are designed for some specific category of users.

If an ePaper display is integrated with a mobile phone that are comparable in size to the mobile phone's LED/LCD display, a user may browse simultaneous or back and forth between both displays. The user may choose to view images that are of limited resolutions, colors, and refresh rates on the ePaper display, such as text, pictures, or slow videos. For children or users concerning eye protection, they may spend about half of their usage time on the ePaper display, which may be a great improvement already. However, the ePaper display should share the mobile phone's original mechanical and electronic units so that the mobile phone could be competitive cost-wise. This new foldable mobile phone should also have some means to adapt images originally for the LED/LCD display to those of appropriate resolutions, colors, and refresh rates for the ePaper display, so that both displays may present similar images.

ePaper displays currently are widely used in eBooks. However, their costs are rather high as, in addition to the ePaper display, eBooks also require mechanical and electronic components at least 70% similar to those of mobile phones. For example, the Nova 3 Color eBooks by the company Onyx are sold for US$400 on-line. If the ePaper display shares a mobile phone's existing mechanical and electronic units, the cost may be reduced to about 20% of that of an eBook but with greater functionality. For example, most existing eBooks, due to cost consideration, are equipped with WIFI communications only. Without 4G/5G communications, existing eBooks usually cannot receive data outdoors. Also as 5G becomes ubiquitous, many users stop having WIFI in their homes. Sharing 5G communications from the mobile phones to the eBook compromises not only transmission speed but also decreases transmission stability. Constant sharing 5G communications also consume the mobile phone's power, thereby reducing the life span of the mobile phone and its battery. Therefore, most users tend to continuously maintain their home WIFI for eBook uses only, and this extra cost may be a factor impeding eBook popularity.

As such, having a mobile phone with an additional integrated ePaper display not only is good for eye health but also promotes the use of ePaper display which will reduce the consumption of paper usage.

### SUMMARY OF THE INVENTION

A major objective of the present invention is to provide a foldable mobile phone including a first member and a second member foldable together through mechanical means. The first member includes electronic components and a LED/LCD display. The second member includes an ePaper display. The LED/LCD display and the ePaper display are electrically connected to the electronic components. The LED/LCD display and the ePaper display show data provided by the electronic components. A user may choose to view the LED/LCD display for text, pictures and continuous videos, or to view the ePaper display for text, pictures, and videos that do not require high resolutions, high numbers of colors, and high refresh rates, so as to reduce damages to the eyes. As the ePaper display share the various mechanical and electronic components with the mobile phone, the cost of the foldable mobile phone is comparable to that of a conventional mobile phone.

The ePaper display is integrated with and shares the various mechanical and electronic components in the first member. The mechanical means allows the mobile phone to be foldable and the Epaper display to become an integral part of the foldable mobile phone. The mechanical means can be similar to the hinges of a notebook computer. The electronic means provides various data like text, pictures, and videos for showing on the displays.

Specifically, the electronic components include a power management unit, a network communication unit, an audio unit, an input/output unit, a camera unit, a central processing unit, a graphic processing unit, a storage unit, and operating system, APPs, and firmware stored in the storage unit.

Specifically, the network communication unit provides wireless 4G, 5G, WIFI, and Bluetooth communications and the network communication unit may include an USB connector.

Specifically, the ePaper display is electrically connected to the electronic components through a flexible printed circuit (FPC).

Specifically, the ePaper display is an electrophoretic or electrowetting display having a resolution, a number of colors, and a refresh rate lower than those of the LED/LCD display.

Specifically, the electronic components include a display control unit adapting images from the LED/LCD display to those of appropriate resolutions, colors, and refresh rates for the ePaper display. For example, 50-fps images will be first determined whether they are colored or black-and-white images and, then, they are delivered as, say, around 8 fps for black-and-white images and 1 fps for colored images to the ePaper display.

Specifically, a pixel and color transformation unit converts images of greater numbers of pixels and colors to those of fewer pixels and colors for display on the ePaper display.

Specifically, the LED/LCD display and the ePaper display are both touch screen displays; and a user interacts with the LED/LCD display by touching the touch screen to enter data control signal to both or one of the displays, or with the ePaper display to enter data control signal to both or one of the displays. Under a power saving mode, the LCD/LED display may be turned off while the images on the ePaper display may be continuously shown.

Specifically, the two displays are respective configured on inner sides of the first and second members.

The advantages of the present invention are as follows.

A user may view both displays simultaneously or selectively view one of the displays. For example, the user may choose to view the LED/LCD display for continuous videos, or to view the ePaper display for text, pictures, or videos that do not require high resolutions, high numbers of colors, and high refresh rates, so as to reduce damages to the eyes.

In addition, unlike the conventional eBooks, the present invention does not require to have and subscribe to a WIFI connection and service. The foldable mobile phone allows a user to take document photos using the built-in camera function, OCR the text of the document photos, store the text into separate electronic file by the first member, and read the file on the ePaper display.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front view diagram showing an existing dual-display mobile phone.

FIG. 2 is a front view diagram showing an existing foldable mobile phone.

FIG. 3 is a front view diagram showing a foldable mobile phone according to an embodiment of the present invention.

FIG. 4 is a functional block diagram showing the foldable mobile phone of FIG. 3.

FIG. 5 is a front view diagram showing the foldable mobile phone of FIG. 3 under a power saving mode.

FIG. 6 is a front view diagram showing the foldable mobile phone of FIG. 3 when different images are respectively shown on two displays.

FIG. 7 is a front view diagram showing the foldable mobile phone of FIG. 3 when it is tilted to a side.

FIG. 8 is a front view diagram showing the foldable mobile phone of FIG. 3 when it is turned upside down.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

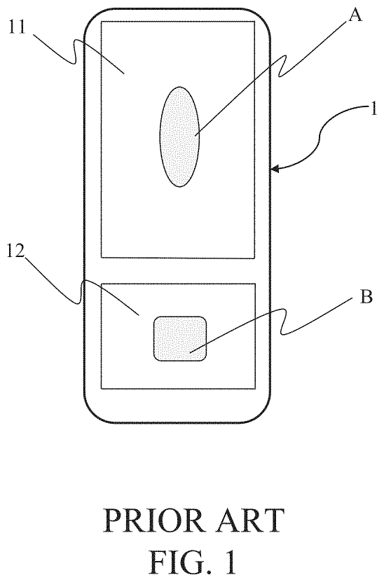

As shown in FIG. 1, a conventional dual-display mobile phone 1 includes a first display 11 and a second display 12. The first display 11 and second display 12 are for showing different images A and B. The second display 12 may also be installed to the mobile phone l′s back side. But it is for showing frequently accessed information such as time or keyboard, not the same as the image A provided by the first display 11.

For example, R.O.C. Taiwan Patent No. 1533656 and U.S. Pat. No. 9,351,334 both have two displays arranged at two sides of a mobile phone. R.O.C. Taiwan Patent No. 1533656 also has one of the displays for showing frequently accessed information such as time. U.S. Pat. Nos. 10,320,962, 10,771,729, and 9,721,529 also have two displays on the same side of a mobile phone. These teachings do not involve foldable phones, the displays are small, and no ePaper display is adopted.

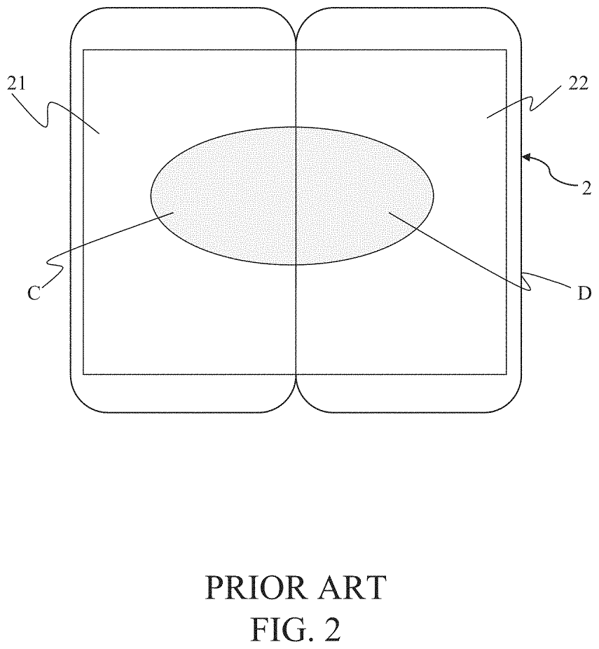

As shown in FIG. 2, an existing foldable mobile phone 2 has a first display 21 and a second display 22 respectively arranged in a left member and a right member of the mobile phone 2, each showing a half image C and another half image D. By combining the images C and D from the first display 21 and the second display 22, an image twice as large is presented.

U.S. Pat. Nos. 10,848,603, 10,491,724, 8,868,142, and 8,264,823, and R.O.C. Taiwan Patent No. 1721672 teach foldable mobile phones to provide an integrated and enlarged display so that the mobile phone would have a display comparable in size to that of a tablet. These teachings, also do not involve an ePaper display.

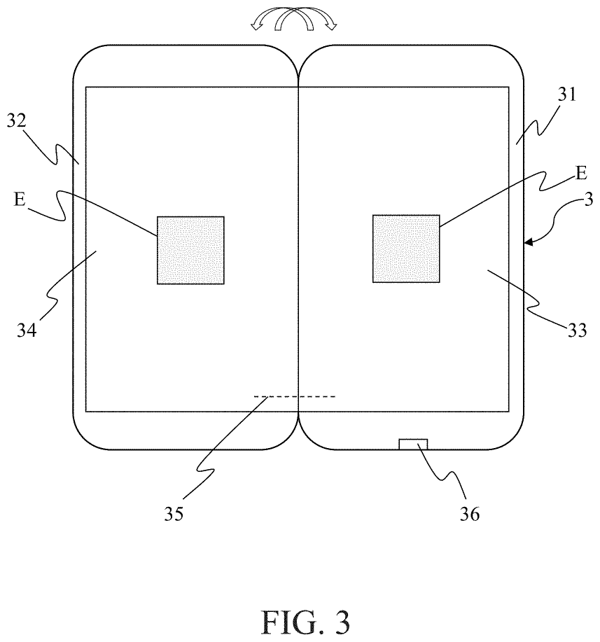

As shown in FIG. 3, a foldable mobile phone according to an embodiment of the present invention includes a foldable mobile phone body 3 having a first member 31 and second member 32. The first member 31 is configured with an existing LED/LCD display 33 for displaying text, picture and video. The second member 32 is configured with an ePaper display 34 for displaying low resolutions and low colors text, picture and low refresh rate video. The first member 31 and the second member 32 are coupled through mechanical and electrical means and the both members share the mobile phone's various mechanical and electrical modules. The mechanical means allows both members to be folded together or unfolded. It can be similar to the hinges of a notebook computer. The electronic means shows various data such as text, pictures, and videos on the displays. As it is commonly known that there are many mobile phones and ePaper displays on the market of different brands and models. Despite some minor differences, they all share a lot of common hardware and functions. The present invention is not aimed to alter these existing hardware and functions, or to adopt some special functions from a particular brand or model. In the present invention, both displays are touch screen displays and both share a display control unit 43 and a touch screen control unit 47. A user may interact with the LED/LCD display 33 by touching the touch screen to enter data control signal to the ePaper display 34, or with the ePaper display 34 to enter data control signal to the LED/LCD display 33. The two displays adopt basically identical hardware components and functionalities to those mobile phones currently available in the market.

A mobile phone module 41 is configured inside the first member 31. The mobile phone module 41 and the ePaper display 34 are connected with a flexible printed circuit (FPC) 35, which include many thin wires. In the drawings, the FPC 35 is denoted by a dashed line as it is housed inside the foldable mobile phone. The FPC 35 provides power and signal communications between the first member 31 and the ePaper display 34. Due to its flexibility, the FPC 35 is not damaged when the foldable mobile phone is folded and unfolded. The first member 31 has an exposed power and signal connector 36, such as an USB Type C connector, which is the same as those found on the existing mobile phones.

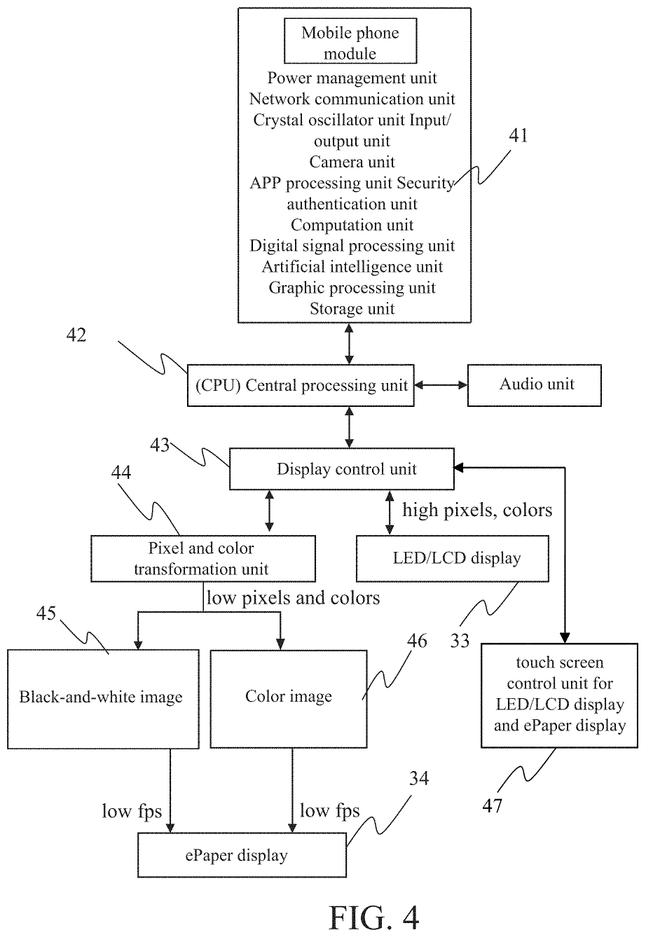

As shown in FIG. 4, the foldable mobile phone module 41 is the same as those that may found in existing mobile phones and, as exemplarily shown, it may include a power management unit, a network communication unit, a crystal oscillator unit, an input/output unit, a camera unit, an APP processing unit, a security authentication unit, a computation unit, a digital signal processing unit, artificial intelligence unit, a graphic processing unit, a storage unit, and operating system, APPs, and firmware stored in the storage unit, etc. The network communication unit provides wireless 4G, 5G, WIFI, and Bluetooth communications; and the network communication unit may include an USB connector. It should be noted that the various units of the foldable mobile phone module 41 are exemplary only, and the present invention is not limited as such. As a matter of fact, the present invention is not about the mobile phone module 41; people skilled in the related art can, based on their needs and requirements, use one of the mobile phone modules available in the market. Therefore, its details are omitted here.

The mobile phone module 41 is connected to a central processing unit 42 and a display control unit 43. The display control unit 43 is connected to a pixel and color transformation unit 44. The central processing unit 42 is also connected to an audio unit in the first member 31. People skilled in the related art can use one of the central processing units 42 and display control units 43 available from the market as long as they fit the needs and requirements. The pixel and color transformation unit 44 transforms data for the LED/LCD display pixels to those for ePaper display pixels, and converts the numbers of colors for the LED/LCD display to an appropriate number of colors for the ePaper display.

Through the display control unit 43 and the pixel and color transformation unit 44, the central processing unit 42 transmits images of different frames per second (FPS), of different pixels, and of different numbers of colors respectively to the LED/LCD display 33 and the ePaper display 34. For example, the images for the LED/LCD display 33 are 50-FPS images. For the ePaper display 34, the images are first determined whether they are black and white image 45 or color images 46. Then, images are transformed so that they are appropriate for the ePaper display 34. For example, 8-FPS images are for black and white images, and 1-FPS images are for color images. In addition, the pixel and color transformation unit 44 reduces the images of greater numbers of pixels for the LED/LCD display 33 to those of smaller numbers of pixels for the ePaper display 34. The pixel and color transformation unit 44 also reduces the images of greater numbers of colors for the LED/LCD display 33 to those of smaller numbers of colors for the ePaper display 34. The display control unit 43 is connected to a touch control screen unit 47 so that the LED/LCD display interacts with the ePaper display 34, and the ePaper display 34 interacts with the LED/LCD display 33 by touching each of the touch screens.

The LED/LCD display 33 and the ePaper display 34 may show an identical image E. When the foldable mobile phone is unfolded, both images E are simultaneously visible. For images E of a higher refresh rate such as a video, most user would prefer the images E shown on the LED/LCD display 33. For images E of a lower refresh rate such as text or picture, most user would prefer the images E shown in the ePaper display 34 which is easier for eyes. Alternatively, the foldable mobile phone of the present embodiment also allows a user to choose to view video of reduced refresh rate on the ePaper display 34. For currently available foldable mobile phones such as Huawei Mate X and Samsung Galaxy Fold, their dual displays have a very small gap in between and the gap is almost not visible. The purpose is to achieve an integrated display that is twice as large. In contrast, the foldable mobile phone of the present embodiment does not require such a small gap between the two displays. The foldable mobile phone of the present embodiment basically adds an additional ePaper display 34, and the ePaper display 34 is not required to be an integral part of the other display. The ePaper display 34 is a separate display but of a small thickness. Therefore, carrying the foldable mobile phone of the present embodiment is just like carrying an ordinary mobile phone.

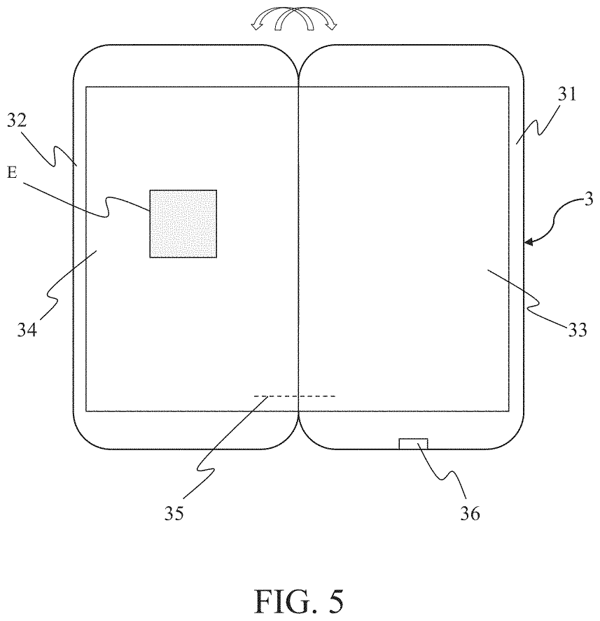

As shown in FIG. 5, the foldable mobile phone of the present embodiment automatically turns off the LED/LCD display 33 when the foldable mobile phone enters a power saving mode whereas the ePaper display 34 would continuously show the image E with little power consumption.

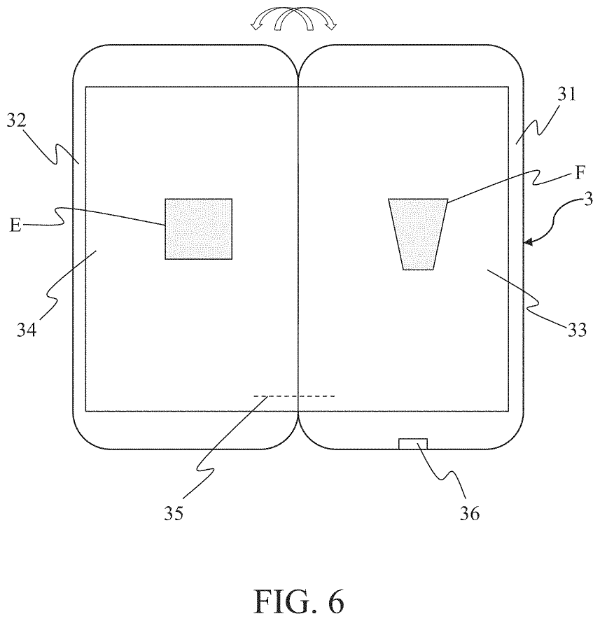

As shown in FIG. 6, the foldable mobile phone of the present embodiment may be configured so that the image E remains shown by the ePaper display 34 whereas the LED/LCD display 33 is switched to show a different image F. In other words, the LED/LCD display 33 and the ePaper display 34 may be configured to show two independent images. In addition, a user may enter data control signal into and interact with ePaper display 34 through the touch screen of the LED/LCD display 33.

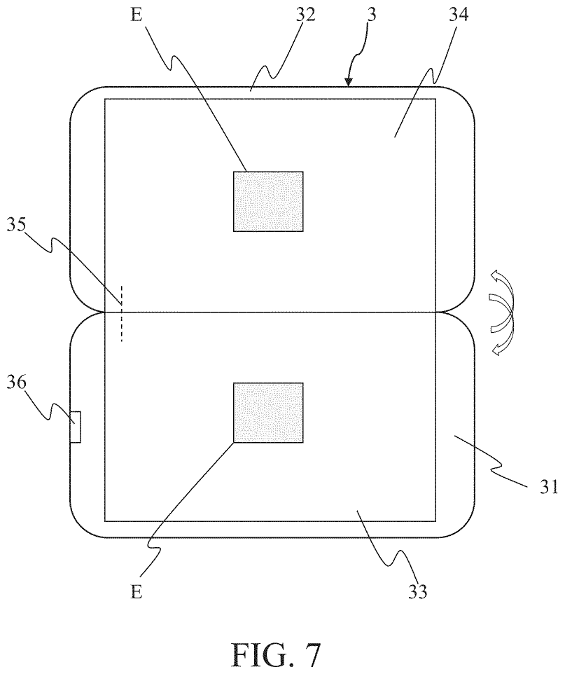

As shown in FIG. 7, as the foldable mobile phone of the present embodiment is tilted into a horizontal orientation, the image E is automatically turned to shown in a landscape mode.

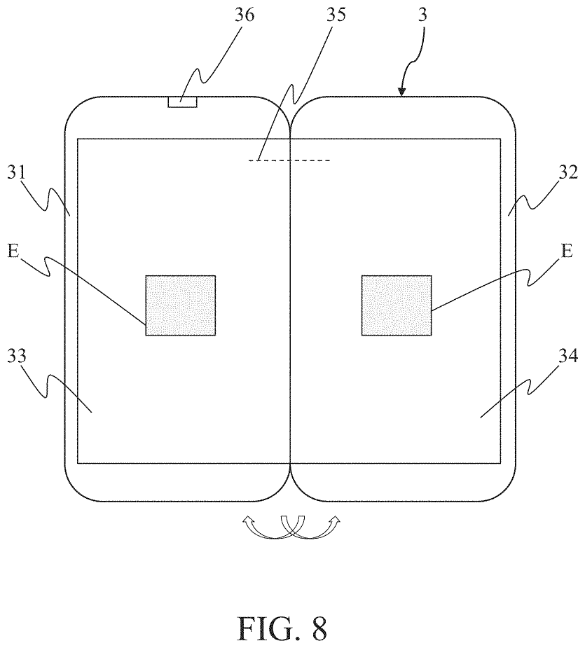

As shown in FIG. 8, the foldable mobile phone of the present embodiment may be turned upside down so that the power and signal connector 36 is now at the top so that a left-handed user may operate the LED/LCD display 33 without blocking the view to the ePaper display 34. This mode of operation may also allow a right-handed user to conduct touch operation on the ePaper display 34. The image E would be automatically turned upside down.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A foldable mobile phone comprising a first member and a second member foldable together through mechanical means, characterized in that:
the first member comprises electronic components and a LED/LCD display;
the second member comprises an ePaper display;
the LED/LCD display and the ePaper display are electrically connected to the electronic components;
wherein the LED/LCD display and the ePaper display show data provided by the electronic components.

2. The mobile phone according to claim 1, wherein the electronic components comprise a power management unit, a network communication unit, an audio unit, an input/output unit, a camera unit, a central processing unit, a graphic processing unit, a storage unit, and operating system, APPs, and firmware stored in the storage unit.

3. The mobile phone according to claim 2, wherein the network communication unit provides wireless 4G, 5G, WIFI, and Bluetooth communications; and the network communication unit comprises an USB connector.

4. The mobile phone according to claim 1, wherein the ePaper display is electrically connected to the electronic components through a flexible printed circuit (FPC).

5. The mobile phone according to claim 1, wherein the ePaper display is an electrophoretic or electrowetting technique display having the numbers of resolutions, colors, and refresh rate lower than those of the LED/LCD display.

6. The mobile phone according to claim 1, wherein the electronic components comprise a display control unit adapting images from the LED/LCD display to those of appropriate resolutions, colors, and refresh rates for the ePaper display.

7. The mobile phone according to claim 1, wherein the LED/LCD display and the ePaper display are both touch screen displays; and a user interacts with the LED/LCD display by touching the touch screen to enter data control signal to both or one of the displays, orby the touch screen of ePaper display to enter data control signal to both or one of the displays.
